(19) United States
(12) Patent Application Publication
(10) Pub. No.: US 2023/0037487 A1
(43) Pub. Date: Feb. 9, 2023

(54) VEHICLE-MOUNTED TRACKING SOLAR POWER GENERATION SYSTEM WITHOUT PHOTOELECTRIC SENSOR

(71) Applicant: Jie LI, Nanning (CN)

(72) Inventor: Jie LI, Nanning (CN)

(21) Appl. No.: 17/969,144

(22) Filed: Oct. 19, 2022

Related U.S. Application Data
(63) Continuation of application No. PCT/CN2020/106964, filed on Aug. 5, 2020.

(51) Int. Cl. H02S 20/32; B60L 8/00

(52) U.S. Cl. CPC H02S 20/32; B60L 8/003

(57) ABSTRACT

The present invention relates to new energy vehicle field, and more particularly to vehicle-mounted tracking solar power generation system without photoelectric sensor. The current vehicle-mounted thin-film solar power generation device has a low power generation, inductive tracking technology has high cost and large volume, so neither of them can meet the electricity demand of new energy vehicles, therefore, at the moment when the photoelectric conversion rate is difficult to effectively improve in the short term, making the vehicle-mounted photovoltaic power generation system not only able to track but also has practicality, has become a technical problem that needs to be solved urgently in the vehicle-mounted solar charging industry, the present invention provides a solar tracking technology that adopts a combination of the orbital device and the platform, does not require real-time tracking and photoelectric sensors, and solves the above-mentioned technical problems well.

### CROSS REFERENCE OF RELATED APPLICATION

This is a Continuation Application of the International Application PCT/CN2020/106964, filed Aug. 5, 2020.

### FIELD OF INVENTION

The present invention relates to new energy vehicle field, and more particularly to vehicle-mounted tracking solar power generation system without photoelectric sensor.

### DESCRIPTION OF RELATED ARTS

With the development and progress of new energy vehicle technology, in the future, new energy vehicles will replace fuel vehicles and be widely popularized, however, the short driving mileage is a technical problem that plagues the smooth development of electric vehicles, although some new energy vehicles will use thin-film solar cells to increase the driving mileage, it is difficult to meet the requirements of thin-film solar cells due to their low power generation and untrackable defects, moreover, the existing tracking technology cannot be applied to new energy vehicles due to the defects of high cost, complex technology and large volume.

### SUMMARY

### Technical Problem to be Solved

At present, it is difficult to effectively improve the photoelectric conversion rate in a short time and when the installed capacity of solar panels is the same, how to improve the power generation of vehicle-mounted solar energy, alleviating the short driving range of new energy vehicles and avoid spontaneous combustion accidents caused by the high temperature inside the vehicles caused by the hot sun in summer are technical problems that need to be solved urgently for new energy vehicles.

### What is the Technical Solution

The present invention does not require photoelectric sensor detection equipment, and does not need to track the sun in real time, it uses non induction type tracking technology is adopted to track at regular time, the technology is simple and high power generation efficiency, so it can be used in low-cost vehicle-mounted tracking solar power generation system, in the PCT international search report, three “yes” positive evaluations were given to the inventiveness, novelty, practicality of the present invention, this positive evaluation fully shows that the present invention and the prior art are two completely different technical solutions, therefore, the invention is an application based on the judgment that the international preliminary examination report is patentable, in view of the above-mentioned defects of the prior art, the present invention provides a vehicle-mounted tracking solar power generation system, which solves the above-mentioned technical problem.

In order to achieve the above objective, the technical solution of the present invention is as follows:

Vehicle-mounted tracking solar power generation system without photoelectric sensor, it includes orbital device, solar angle controller, steel frame, the orbital device includes a base, track, bracket, platform, solar panel, T-shaped beam, driving device, pulley, turntable, solar panels include three different types: PV panels, thin-film solar panels, and flexible crystalline solar panels, based on the frame of the vehicle roof, a steel structure frame is fixedly installed, a splitter plate with air resistance is installed at the end of the frame facing the front of the vehicle, the splitter plate is in the shape of an arch, the middle is high and the ends are low, and the cross section is a polygon with an arc, the splitter plate is fixed on the support frame, the shape of the support frame is the same as that of the splitter plate and is also arched, it contains longitudinal beams and cross beams, and is fixed on the frame of the steel structure by support rods, a circular orbital is fixedly installed on the frame, the shape of the cross section of the orbital is divided into two types: L-shaped or polygonal, a ring-shaped groove components is pre-embedded on both sides of each track, and the opening of the groove components is narrow at the top and wide at the bottom, a ring-shaped groove components is also pre-embedded on the wall of the L-shaped section, there are three, the base of the polygonal section has only two grooved components, a round or triangular bracket is installed on the track, X pulleys are installed under the circular bracket, and one pulley is installed at each corner of the triangular bracket, there are hanging beams or chains fixedly installed on both sides of the pulley shaft, the lower end of each beam or chain has a circular or polygonal component, when the beams or chains are inserted into the grooves on both sides of the track, the components stuck in the grooves and move with the pulleys, for the pulley on the L-shaped truncated surface track, one end of the component is stuck in the groove on the upper wall of the track, and the other end is directly fixed or fixed on the shaft of the pulley through a chain, a turntable is fixedly installed in the center of the circular or triangular bracket, the two ends of the S root beams are respectively fixed on the turntable and the round or triangular bracket or the shaft of the pulley, a polygonal or circular frame is fixedly installed above the circular or triangular bracket, Y root T-shaped beams are fixedly installed on the periphery of the polygonal or circular frame, in the T-shaped beams, there are component with H set hinge device installed at the top of one side, and H set of driving device are installed on the other side corresponding to it, except for the T-shaped beam with hinged device, a U-shaped frame is fixed on the top of the other T-shaped beams, an electronic lock or electromagnet is installed on the U-shaped frame, a polygonal or circular platform is installed on the T-shaped beams and the driving devices, among the frame beams at the bottom of the platform, one is hinged with the T-shaped beam to form a hinged device, and the remaining frame beams are placed in the U-shaped frame of the T-shaped beam, the top of the driving device is fixedly connected with the platform by bolts, the turntable is an smart electric column whose column body is mainly composed of a shaft and a hollow tube, the hollow tube is fixed on the shaft and rotates with the shaft and cannot move up and down, the turntable base is fixed on the steel frame, S root beams are fixedly installed on the column body of the turntable, the driving device is an smart electric column that can be raised and lowered, the column body is mainly composed of a polygonal or circular nut, a threaded shaft, and a T-shaped hollow tube, the T-shaped hollow tube is fixed on the nut to form a whole, and the nut moves up and down along the shaft, the driving of the above-mentioned intelligent electric column by a motor combination, and the motor combination is composed of a motor and a mechanical transmission mechanism, the motor combination is fixed in the machine base, when the driving device is fully retracted, the polygonal or circular platform is in a horizontal state, the solar panel are fixed on the platform and parallel to the platform, and rotates with the platform, the adjustment of the angle of the solar panel is replaced by adjusting the angle of a polygonal or circular platform, it will be controlled by a solar angle controller with an embedded angle sensor, the solar angle controller is an smart control device which controls the angle of a polygon or circular platform to change by using time timing, it mainly includes main chip, angle sensor, GPS satellite positioning or electronic compass, clock chip, Bluetooth, motor-driven module, the main chip reads the real-time clock and angle value, and controls the change of the polygonal or circular platform angle according to different time periods, after the solar angle controller is powered on, the clock chip will automatically use GPS or Bluetooth to check the time, the working principle of polygonal or circular platform angle adjustment is: the solar angle controller and the polygonal or circular platform are installed on the same horizontal plane, when the time reaches the preset time, the solar angle controller receives a signal of angle adjustment through GPS satellite positioning or electronic compass positioning, then, the angle detection module is made to rotate by controlling the control module of the motor to make the polygonal or circular platform complete the horizontal or inclined action, at this time, the smart electric column will complete the horizontal or extension or contraction movement with the rotation of the motor, while the polygonal or circular platform is pushed to the predetermined position, the analog output from the angle sensor is converted by the analog-digital converter and then sent to the main controller, according to this input, the main controller determines whether the polygonal or circular platform has been rotated to a predetermined angle, and according to this to control the control module of the motor, thus one angle adjustment is completed, in the many times adjustment mode within 1 day of dip angle, the angle value newly adjusted each time is ψ−J*ψ/F in the morning period, at noon, the dip angle is fixed, and it is γ+ψ/F in the afternoon, the inclination angle value that needs to be adjusted each time, together with its corresponding analog voltage value or adjustment time, is input into the storage module of the controller in advance, the specific implementation is: when the angle sensor is in the horizontal position and the angle is 0°, the output terminal Vo outputs an analog voltage of A volts, when the angle value W of the maximum dip angle between the angle sensor and the horizontal plane, the output at this time is the analog voltage of B volts, when the angle of the angle sensor changes in the interval of 0°˜ψ or ψ˜180°, the voltage output by the output terminal Vo will sequentially change from A volts to B volts or B volts to A volts analog voltage signal, therefore, by measuring the voltage at the output terminal Vo of the angle sensor, the angle between the polygonal or circular platform and the horizontal plane can be determined, the component of the hinge device is composed of a bottom plate and a C-block polygonal vertical plate, one end of the vertical plate with a circular arc has a hole, and the other end is fixed on the bottom plate, the components of the hinged device, when C=2, are fixed connections, when C>2, it is hinged connection to form a hinged device, when the battery supplies power to the vehicle air conditioner, it will be connected to the vehicle air conditioner through an automatic switch converter to provide power to the vehicle air conditioner, it is characterized in that: no photoelectric sensor device is needed, through the combination of orbital device and polygonal or circular platform, a 2-dimensional tracking solar charging system is constructed; using time timing, the angle adjustment of the solar panel are controlled by a solar angle controller, the solar angle controller using time timing, controlling the smart electric column or driving motor to drive the azimuth angle or the dip angle of the polygonal or circular platform, to move horizontally to the east or west, or to rotate from east to west, thus, the azimuth or dip angle of the polygonal or circular platform is adjusted to change with the change of time, the order of adjustment is azimuth adjustment first and dip angle later, the azimuth angle is adjusted by the solar angle controller to control it to rotate eastward or westward according to the signal output by the GPS or the electronic compass module, the adjustment of the dip angle is a beforehand inputting method, the beforehand inputting method is the dip angle value calculated by the arithmetic average method of the maximum inclination angle, it is a control mode in which the inclination angle value that needs to be adjusted each time, together with its corresponding analog voltage value or adjustment time are input into the controller in advance, the maximum dip angle that PV panels can form, a calculation method for arithmetic average according to the number of adjustments, the time timing is three or more times in a day, the adjusted time period of the 2-dimensional tracking is divided into three time periods: morning, noon, and afternoon, when three adjustments in one day, the polygonal or circular platform is facing east in the morning, with the largest dip angle, and horizontal at noon; in the afternoon, facing the west with the largest dip angle, the many times adjustments refer to two periods in the morning or afternoon, the azimuth angle is adjusted every E minutes, and the dip angle is adjusted F times in E minutes, the angle value of the maximum dip angle ψ of the polygonal or circular platform in the input method is divided into F times in arithmetic average, the angle value of each adjustment is ψ/F, the orientation of the polygonal or circular platform adjusted for many times is the same as that adjusted for three times within one day, in the morning, the newly adjusted angle value is ψ−J*ψ/F each time, J is an integer number series value, the minimum value is 1, the maximum value is F; in the afternoon, the newly adjusted angle value is γ+ψ/F each time, γ is the angle value at the previous moment of adjustment, every time the azimuth is adjusted, the dip angle has returned to the initial position.

### Beneficial Effect

The invention can not only alleviate the insufficient cruising range of new energy vehicles, but also reduce the problem of auto-ignition accidents caused by excessively high temperature in the vehicle during summer, more importantly, it solves the urgent technical problems in the field of new energy vehicle-mounted solar power generation, that is, solar power generation must not only be able to track the sun, but also have practical value problems.

### BRIEF DESCRIPTION OF THE DRAWINGS

FIG. 1 is a plan top view of solar power generation system: 1—solar panels, 2—T-shaped beam with U-shaped frame, 3—T-shaped beam, 4—polygonal or circular platform, 5—round or triangular bracket, 6—pulley, 7—orbital device, 8—S root beam, 9—turntable, 10—drive device;

FIG. 2 is a front view of solar power generation system: 11—polygonal or circular frame, 12—hinge device, 13—steel frame;

FIG. 3 is a front view of orbital with L-section, 14—groove components;

FIG. 4 is a front view of orbital with polygonal section.

### DETAILED DESCRIPTION OF THE PREFERRED EMBODIMENT

### Preferred Embodiment of the Present Invention

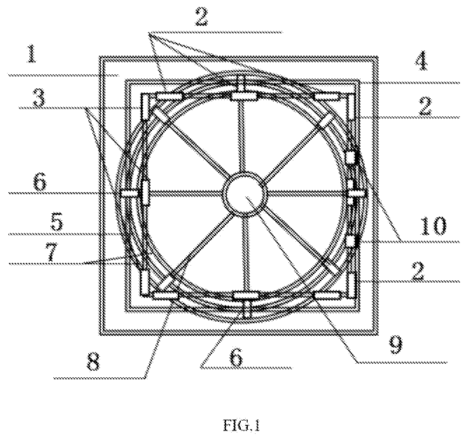

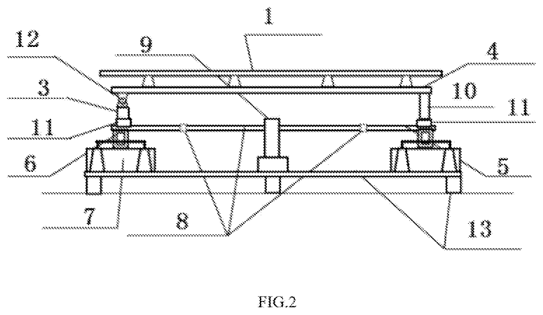

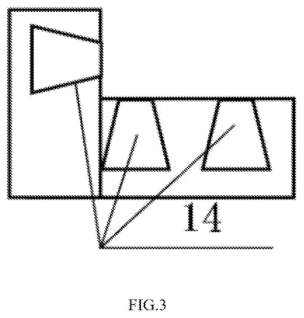

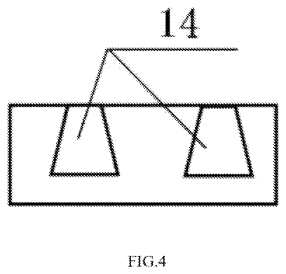

Refer to FIGS. 1-4, photovoltaic panel 1 is fixed on polygonal or circular platform 4 with fixed support 12, the frame beams of the polygonal or circular platform 4 is hinged with the T-shaped beam 3 to form a hinged device, it is fixedly connected with the driving device 10 of sleeve H, and the rest are placed on the T-shaped beam 2 with a U-shaped frame, the driving device 10 and the T-shaped beams 2 and 3 are fixed on the polygonal or circular frame 11, the frame 11 is fixed on the circular or triangular bracket 5, and the bracket 5 is fixed on the pulley 6, the beams or chains on both sides of the shaft of the pulley 6 are inserted into the groove 14 of the orbital 7 and move with the pulley 6, the round or triangular bracket 5 and the turntable 9 are respectively connected to the two ends of the S root beam 8, and the orbital 7 and the turntable 9 are fixed on the steel structure frame 13, thus, a 2-dimensional tracking solar power generation system without photoelectric sensor is formed, when the vehicle is driving, the solar panel 1 is in a horizontal state to generate electricity, when the vehicle is stable in the parking lot, turn on the adjustment switch in the vehicle or start the switch through the APP, the electronic lock of the T-shaped beam 2 is opened or the electromagnet is powered off, the platform is separated from the U-shaped frame, and the tracking system is turned on.

### Preferred Embodiment of the Invention

The angle adjustment is three or more times in one day, the adjusted time period of the 2-dimensional tracking is divided into three time periods: morning, noon, and afternoon, when three adjustments in one day, the polygonal or circular platform is facing east in the morning, with the largest dip angle, and horizontal at noon; in the afternoon, facing the west with the largest dip angle, the many times adjustments refer to two periods in the morning or afternoon, the azimuth angle is adjusted every E minutes, and the dip angle is adjusted F times in E minutes, the angle value of the maximum dip angle ψ of the polygonal or circular platform in the input method is divided into F times in arithmetic average, the angle value of each adjustment is ψ/F, the orientation of the polygonal or circular platform adjusted for many times is the same as that adjusted for three times within one day, in the morning, the newly adjusted angle value is ψ−J*ψ/F each time, J is an integer number series value, the minimum value is 1, the maximum value is F; in the afternoon, the newly adjusted angle value is γ+ψ/F each time, γ is the angle value at the previous moment of adjustment, every time the azimuth is adjusted, the dip angle has returned to the initial position.

The system first adjusts the azimuth angle of the polygonal or circular platform 4, it will use the electronic compass module to determine, the solar angle controller will obtain the azimuth angle of the sun facing east or west according to the signal output by the electronic compass module, the rotation of the turntable 9 is controlled by the solar angle controller, the S root beam drives the pulley 6 of the circular or triangular bracket 5 to move, and the azimuth angle of the polygonal or circular platform 4 is adjusted in place, the solar angle controller drives the driving device 10 to start adjusting the dip angle of the polygonal or circular platform 4, when the polygonal or circular platform 4 arrives at the scheduled time, in the morning and the high noon, the solar angle controller drives the turntable 9 to adjust the azimuth to the east, in the afternoon, it faces the west, for three adjustments within one day, during the morning period, the solar angle controller controls the driving device 10 to fully extend and adjust the polygon or circular platform 4 to face the east; during the high noon period, the driving device 10 to fully retracts and adjusts the polygonal or circular platform 4 to be horizontal; during the afternoon period, the driving device 10 to fully extend and adjust that the polygonal or circular platform 4 faces west, for many times adjustments within one day, the adjustment principle of polygonal or circular platform 4 in each time period is consistent with the above, refer to paragraphs 0016˜0017 for details, after the angle adjustment of the platform is completed, the driving device 10 fully retracts, and the polygonal or circular platform 4 returns to the horizontal state, if the vehicle starts and the polygonal or circular platform 4 is not homing, that is, the polygonal or circular platform 4 is horizontal and parallel to the vehicle head, on the joist the electronic lock is closed or the electromagnet is energized, a warning sound will be given in the driver's cab.

The electric power generated by the vehicle-mounted solar power generation system of the present invention can solve the problems of insufficient power supply for the battery charging of the new energy vehicle and the air conditioner in the vehicle, this can relieve the short driving range problem of new energy vehicles and avoid spontaneous combustion accidents caused by the high temperature inside the vehicles caused by the hot in summer, during the above charging process, the battery supplies power to the air conditioner in the car every certain time to release the cold air, so as to avoid excessive temperature in the vehicles, the above charging method is also applicable to current fuel vehicles, when the battery supplies power to the car air conditioner, it will be connected to the car air conditioner through an automatic switch converter to provide power to the car air conditioner, automatic switching converters are divided into two types: integrated automatic transfer switches and molded case circuit breakers, the automatic switching converter preferentially uses the battery power supply of solar cell power generation, that is, the solar cell power generation is the main power supply, and the vehicle battery is the standby power supply, when the voltage or current Q of the main power supply is higher than the voltage or current I value of the set threshold, the main power supply is automatically switched on, and the backup power supply is on standby; When the main power supply fails or the voltage or current of the main power supply is lower than the set threshold voltage or current I value, the standby power supply is put into use; Q value is greater than I value, but the standby power supply is lower than the set protection threshold, even if Q value is less than I value, the power will be cut off automatically, when the battery is used for power supply, It is to supply power for K minutes every W minutes, K<W.

### INDUSTRIAL APPLICABILITY

The 2-dimensional tracking technology without photoelectric sensor provided by the invention, it is a solar tracking technology that uses a combination of orbital devices and platforms, and does not require real-time tracking and photoelectric sensors, the cost performance of the 2-dimensional tracking solar power generation system of the present invention is greatly improved, and its technology is simple, low cost, and high power generation efficiency, it can not only alleviate the short driving range of new energy vehicles, but also avoid spontaneous combustion accidents caused by the high temperature inside the vehicles caused in summer, more importantly, it solves the technical problems that need to be solved urgently in the field of new energy vehicle-mounted solar power generation, that is, solar power generation must not only be able to be track, but also have practical value.

What is claimed is:

1. Vehicle-mounted tracking solar power generation system without photoelectric sensor, it includes orbital device, solar angle controller, steel frame, the orbital device includes a base, track, bracket, platform, solar panel, T-shaped beam, driving device, pulley, turntable, solar panels include three different types: PV panels, thin-film solar panels, and flexible crystalline solar panels, based on the frame of the vehicle roof, a steel structure frame is fixedly installed, a splitter plate with air resistance is installed at the end of the frame facing the front of the vehicle, the splitter plate is in the shape of an arch, the middle is high and the ends are low, and the cross section is a polygon with an arc, the splitter plate is fixed on the support frame, the shape of the support frame is the same as that of the splitter plate and is also arched, it contains longitudinal beams and cross beams, and is fixed on the frame of the steel structure by support rods, a circular orbital is fixedly installed on the flame, the shape of the cross section of the orbital is divided into two types: L-shaped or polygonal, a ring-shaped groove components is pre-embedded on both sides of each track, and the opening of the groove components is narrow at the top and wide at the bottom, a ring-shaped groove components is also pre-embedded on the wall of the L-shaped section, there are three, the base of the polygonal section has only two grooved components, a round or triangular bracket is installed on the track, X pulleys are installed under the circular bracket, and one pulley is installed at each corner of the triangular bracket, there are hanging beams or chains fixedly installed on both sides of the pulley shaft, the lower end of each beam or chain has a circular or polygonal component, when the beams or chains are inserted into the grooves on both sides of the track, the components stuck in the grooves and move with the pulleys, for the pulley on the L-shaped truncated surface track, one end of the component is stuck in the groove on the upper wall of the track, and the other end is directly fixed or fixed on the shaft of the pulley through a chain, a turntable is fixedly installed in the center of the circular or triangular bracket, the two ends of the S root beams are respectively fixed on the turntable and the round or triangular bracket or the shaft of the pulley, a polygonal or circular frame is fixedly installed above the circular or triangular bracket, Y root T-shaped beams are fixedly installed on the periphery of the polygonal or circular frame, in the T-shaped beams, there are component with H set hinge device installed at the top of one side, and H set of driving device are installed on the other side corresponding to it, except for the T-shaped beam with hinged device, a U-shaped frame is fixed on the top of the other T-shaped beams, an electronic lock or electromagnet is installed on the U-shaped frame, a polygonal or circular platform is installed on the T-shaped beams and the driving devices, among the frame beams at the bottom of the platform, one is hinged with the T-shaped beam to form a hinged device, and the remaining frame beams are placed in the U-shaped frame of the T-shaped beam, the top of the driving device is fixedly connected with the platform by bolts, the turntable is an smart electric column whose column body is mainly composed of a shaft and a hollow tube, the hollow tube is fixed on the shaft and rotates with the shaft and cannot move up and down, the turntable base is fixed on the steel frame, S root beams are fixedly installed on the column body of the turntable, the driving device is an smart electric column that can be raised and lowered, the column body is mainly composed of a polygonal or circular nut, a threaded shaft, and a T-shaped hollow tube, the T-shaped hollow tube is fixed on the nut to form a whole, and the nut moves up and down along the shaft, the driving of the above-mentioned intelligent electric column by a motor combination, and the motor combination is composed of a motor and a mechanical transmission mechanism, the motor combination is fixed in the machine base, when the driving device is fully retracted, the polygonal or circular platform is in a horizontal state, the solar panel are fixed on the platform and parallel to the platform, and rotates with the platform, the adjustment of the angle of the solar panel is replaced by adjusting the angle of a polygonal or circular platform, it will be controlled by a solar angle controller with an embedded angle sensor, the solar angle controller is an smart control device which controls the angle of a polygon or circular platform to change by using time timing, it mainly includes main chip, angle sensor, GPS satellite positioning or electronic compass, clock chip, Bluetooth, motor-driven module, the main chip reads the real-time clock and angle value, and controls the change of the polygonal or circular platform angle according to different time periods, after the solar angle controller is powered on, the clock chip will automatically use GPS or Bluetooth to check the time, the working principle of polygonal or circular platform angle adjustment is: the solar angle controller and the polygonal or circular platform are installed on the same horizontal plane, when the time reaches the preset time, the solar angle controller receives a signal of angle adjustment through GPS satellite positioning or electronic compass positioning, then, the angle detection module is made to rotate by controlling the control module of the motor to make the polygonal or circular platform complete the horizontal or inclined action, at this time, the smart electric column will complete the horizontal or extension or contraction movement with the rotation of the motor, while the polygonal or circular platform is pushed to the predetermined position, the analog output from the angle sensor is converted by the analog-digital converter and then sent to the main controller, according to this input, the main controller determines whether the polygonal or circular platform has been rotated to a predetermined angle, and according to this to control the control module of the motor, thus one angle adjustment is completed, in the many times adjustment mode within 1 day of dip angle, the angle value newly adjusted each time is ψ−J*ψ/F in the morning period, at noon, the dip angle is fixed, and it is γ+ψ/F in the afternoon, the inclination angle value that needs to be adjusted each time, together with its corresponding analog voltage value or adjustment time, is input into the storage module of the controller in advance, the specific implementation is: when the angle sensor is in the horizontal position and the angle is 0°, the output terminal Vo outputs an analog voltage of A volts, when the angle value ψ of the maximum dip angle between the angle sensor and the horizontal plane, the output at this time is the analog voltage of B volts, when the angle of the angle sensor changes in the interval of 0°˜ψ or ψ˜180°, the voltage output by the output terminal Vo will sequentially change from A volts to B volts or B volts to A volts analog voltage signal, therefore, by measuring the voltage at the output terminal Vo of the angle sensor, the angle between the polygonal or circular platform and the horizontal plane can be determined, the component of the hinge device is composed of a bottom plate and a C-block polygonal vertical plate, one end of the vertical plate with a circular arc has a hole, and the other end is fixed on the bottom plate, the components of the hinged device, when C=2, are fixed connections, when C>2, it is hinged connection to form a hinged device, when the battery supplies power to the vehicle air conditioner, it will be connected to the vehicle air conditioner through an automatic switch converter to provide power to the vehicle air conditioner, it is characterized in that: no photoelectric sensor device is needed, through the combination of orbital device and polygonal or circular platform, a 2-dimensional tracking solar charging system is constructed: using time timing, the angle adjustment of the solar panel are controlled by a solar angle controller.

2. Vehicle-mounted tracking solar power generation system without photoelectric sensor according to claim 1, characterized in that: the solar angle controller using time timing, controlling the smart electric column or driving motor to drive the azimuth angle or the dip angle of the polygonal or circular platform, to move horizontally to the east or west, or to rotate from east to west, thus, the azimuth or dip angle of the polygonal or circular platform is adjusted to change with the change of time, the order of adjustment is azimuth adjustment first and dip angle later, the azimuth angle is adjusted by the solar angle controller to control it to rotate eastward or westward according to the signal output by the GPS or the electronic compass module, the adjustment of the dip angle is a beforehand inputting method, the beforehand inputting method is the dip angle value calculated by the arithmetic average method of the maximum inclination angle, it is a control mode in which the inclination angle value that needs to be adjusted each time, together with its corresponding analog voltage value or adjustment time are input into the controller in advance, the maximum inclination arithmetic averaging method refers to the period of morning or afternoon, the maximum dip angle that PV panels can form, a calculation method for arithmetic average according to the number of adjustments.

3. Vehicle-mounted tracking solar power generation system without photoelectric sensor according to claim 2, characterized in that: the time timing is three or more times in a day, the adjusted time period of the 2-dimensional tracking is divided into three time periods: morning, noon, and afternoon, when three adjustments in one day, the polygonal or circular platform is facing east in the morning, with the largest dip angle, and horizontal at noon; in the afternoon, facing the west with the largest dip angle, the many times adjustments refer to two periods in the morning or afternoon, the azimuth angle is adjusted every E minutes, and the dip angle is adjusted F times in E minutes, the angle value of the maximum dip angle ψ of the polygonal or circular platform in the input method is divided into F times in arithmetic average, the angle value of each adjustment is ψ/F, the orientation of the polygonal or circular platform adjusted for many times is the same as that adjusted for three times within one day, in the morning, the newly adjusted angle value is ψ−J*ψ/F each time, J is an integer number series value, the minimum value is 1, the maximum value is F; in the afternoon, the newly adjusted angle value is γ+ψ/F each time, ψ is the angle value at the previous moment of adjustment, every time the azimuth is adjusted, the dip angle has returned to the initial position.
